(19) United States
(12) Patent Application Publication
(10) Pub. No.: US 2008/0117081 A1
(43) Pub. Date: May 22, 2008

(54) Portable traffic analyzer

(76) Inventors: Peter Jerome Radusewicz, West Newton, PA (US); Thomas Christopher Rae, Irwin, PA (US); Angelo Libertino, Uniontown, PA (US)

Correspondence Address: BRINKS HOFER GILSON & LIONE, P.O. BOX 10395, CHICAGO, IL, 60610, US

(21) Appl. No.: 11/716,934

(22) Filed: Mar. 12, 2007

Related U.S. Application Data
(60) Provisional application No. 60/860,193, filed on Nov. 17, 2006.
(60) Provisional application No. 60/860,451, filed on Nov. 20, 2006.

(51) Int. Cl. G08G 1/015

(52) U.S. Cl. 340/933

(57) ABSTRACT

A traffic analyzer for detecting a magnetic permeable mass passing a fixed position includes a calibrated magnetic background memory device, a first magnetic field detector, a second magnetic field detector, a window comparator, and a programmable processor. The first magnetic field detector is operative to detect a change in a magnetic field caused by a magnetic permeable mass passing the magnetic field detector. The window comparator then generates a comparative output of the detected change and a threshold value stored in the calibrated magnetic background memory device. The window comparator then generates a comparative output to place the programmable processor in an active state. The programmable processor is then operative to calculate characteristic data of the magnetic permeable mass using the output from the first and second magnetic field detectors. The characteristic data may be stored in a memory storage device according to a dynamic distribution classification.

### RELATED APPLICATIONS

This application claims the benefit of priority to U.S. Provisional Application Ser. No. 60/860,193, filed Nov. 17, 2006, entitled “Portable Traffic Analyzer,” which is incorporated by reference herein, and U.S. Provisional Application Ser. No. 60/860,451, filed Nov. 20, 2006, entitled “Portable Traffic Analyzer,” which is incorporated by reference herein.

### BACKGROUND

1. Technical Field

The present embodiments relate to a vehicle traffic analyzer operative to analyze the characteristic data of passing vehicles. In particular, the present embodiments relate to an analyzer operative to analyze passing vehicles using a lead sensor, a lag sensor, and a programmable processor.

3. Related Art

Traffic sensors are often used to detect the flow of traffic. For example, traffic sensors as disclosed in U.S. Pat. No. 5,877,705, which is incorporated by reference herein, and U.S. Pat. No. 5,748,108, which is incorporated by reference herein, can be used to detect traffic. However, the data gathered by the traffic sensors must often undergo analysis after being recorded, which can be a very time consuming process. Today's traffic sensors simply record data and it is up to the user of the traffic analyzer to make any meaningful sense out of the data.

Furthermore, today's traffic sensors rely on the changes in a magnetic field near the traffic sensor to determine whether a vehicle has passed. However, these traffic sensors are often unable to distinguish whether changes in the magnetic field are due to a passing vehicle or some other phenomenon. Thus, when a false positive is recorded, that is, a change in the magnetic field near the traffic sensor not due to a passing vehicle, a user must be savvy enough to recognize that a false positive has been recorded. Otherwise, the false positive can skew the data recorded by the traffic sensor.

### SUMMARY

By way of introduction, the embodiments described below include a system and a method for analyzing vehicular traffic. In one embodiment, the system includes a calibrated magnetic background memory device, a first magnetic field detector, a second magnetic field detector, a programmable processor, and a memory storage device. The first magnetic field detector is operative to produce a first output indicative of a first change in a magnetic field caused by a magnetic permeable mass. For example, the first magnetic field detector may detect a change in a magnetic field caused by vehicle. The second magnetic field detector is operative to produce a second output indicative of a second change in the magnetic field caused by the magnetic permeable mass. For example, the second magnetic field detector may detect a second change in a magnetic field caused by the same vehicle that caused a change in the magnetic field detected by the first magnetic field detector. In one embodiment, the second magnetic field detector is spaced apart from the first magnetic field detector at a predetermined distance. The distance may be measured in millimeters, centimeters, inches, feet, or any other now known or later developed measuring distance, or combinations thereof. Examples of magnetic field detectors include the magnetic field sensors as disclosed in U.S. Pat. No. 5,877,705, and the magnetic field sensors as disclosed in U.S. Pat. No. 5,748,108.

In this first embodiment, the programmable processor is coupled with the first and second magnetic field detectors. The programmable processor is operative to receive the first output of the first magnetic field detector and the second output of the second magnetic field detector to produce an output of characteristic data of the magnetic permeable mass. Characteristic data includes, but is not limited to, speed, length, or any other similar characteristic of a magnetic permeable mass, such as a vehicle, and the number of magnetic permeable masses that have passed a fixed position. The term vehicle includes, but is not limited to, a device or structure for transporting persons or things. The device or structure for transporting persons or things may be powered or unpowered. Examples of vehicles include cars, trucks, planes, bicycles, motorcycles, and scooters. In this first embodiment, the programmable processor is activated based on a comparison of the first change in the magnetic field and a threshold value stored in the calibrated magnetic background memory device. The programmable processor is further operative to store the characteristic data and/or analysis of the characteristic data based on a dynamic distribution classification in a memory storage device coupled with the programmable processor.

In another embodiment of the system disclosed herein, the traffic analyzer includes a calibrated magnetic background memory device calibrated with a threshold value, a first magnetic field detector, a second magnetic field detector, a first analog-to-digital converter, a second analog-to-digital converter, a window comparator, and a programmable processor. In this alternative embodiment, the first magnetic field detector and the second magnetic field detector produce an analog output indicative of a change in a magnetic field caused by a magnetic permeable mass, such as a vehicle. Further included in this embodiment is a window comparator that compares the analog output of the first magnetic field detector to a threshold value. Based on this comparison, the window comparator is operative to activate the programmable processor coupled with the first and second magnetic field detectors

In this embodiment, analog-to-digital converters coupled with the first and second magnetic field detectors convert the analog output of the first and said second magnetic field detectors to digital output for processing by the programmable processor. The programmable processor is then operative to generate characteristic data indicative of the magnetic permeable mass. The programmable processor then communicates with a memory storage device that stores the characteristic data output by the programmable processor. In this alternative embodiment, the programmable processor stores the characteristic data in the memory storage device according to a dynamic distribution classification.

The invention disclosed herein further includes a method for detecting a magnetic permeable mass passing the fixed position. In one embodiment, the method includes determining a threshold value and detecting a change in a magnetic field in response to a magnetic permeable mass passing a fixed position. The method further includes generating an analog output indicative of the detected change in the magnetic field and comparing the analog output with the threshold value. The method additionally involves generating a comparative output where the analog output value exceeds the threshold value and generating a digital output value based on the analog output. Finally, the method includes activating a programmable processor to output characteristic data based on the digital output value, the programmable processor being activated based on the comparative output.

The present invention is defined by the following claims, and nothing in this section should be taken as a limitation on those claims. Further aspects and advantages of the embodiments are discussed below in conjunction with the preferred embodiments and may be later claimed independently or in combination.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of one embodiment of a traffic analyzer for analyzing characteristic data of a magnetic permeable mass.

FIG. 2 is a block diagram of an alternative embodiment of a traffic analyzer for analyzing characteristic data of a magnetic permeable mass.

FIG. 3 is a block diagram of another embodiment of a traffic analyzer for analyzing characteristic data of a magnetic permeable mass.

FIG. 4 is an illustration of a traffic analyzer in use to analyze the characteristic data of a magnetic permeable mass.

FIG. 5 is an illustration of a traffic analyzer in communication with additional systems to analyze the characteristic data of a magnetic permeable mass.

FIG. 6 is an illustration of multiple traffic analyzers in use to analyze the characteristic data of multiple magnetic permeable masses.

FIG. 7 is an example of a time-series magnitude plot used to calculate the speed and mass of a magnetic permeable mass according to one embodiment of the traffic analyzer.

FIG. 8 is a flow chart of one embodiment of a method for analyzing the characteristic data of a magnetic permeable mass.

FIG. 9 is a flow chart of one embodiment of calibrating a traffic analyzer used to analyze the characteristic data of a magnetic permeable mass.

FIG. 10A is a flow chart of one embodiment for detecting a magnetic permeable mass according to the flow chart shown in FIG. 7.

FIG. 10B is a flow chart illustrating the detection of the magnetic permeable mass continued from FIG. 10A.

FIG. 11 is a flow chart of one embodiment for processing the output of the sensors of the traffic analyzer.

### DETAILED DESCRIPTION

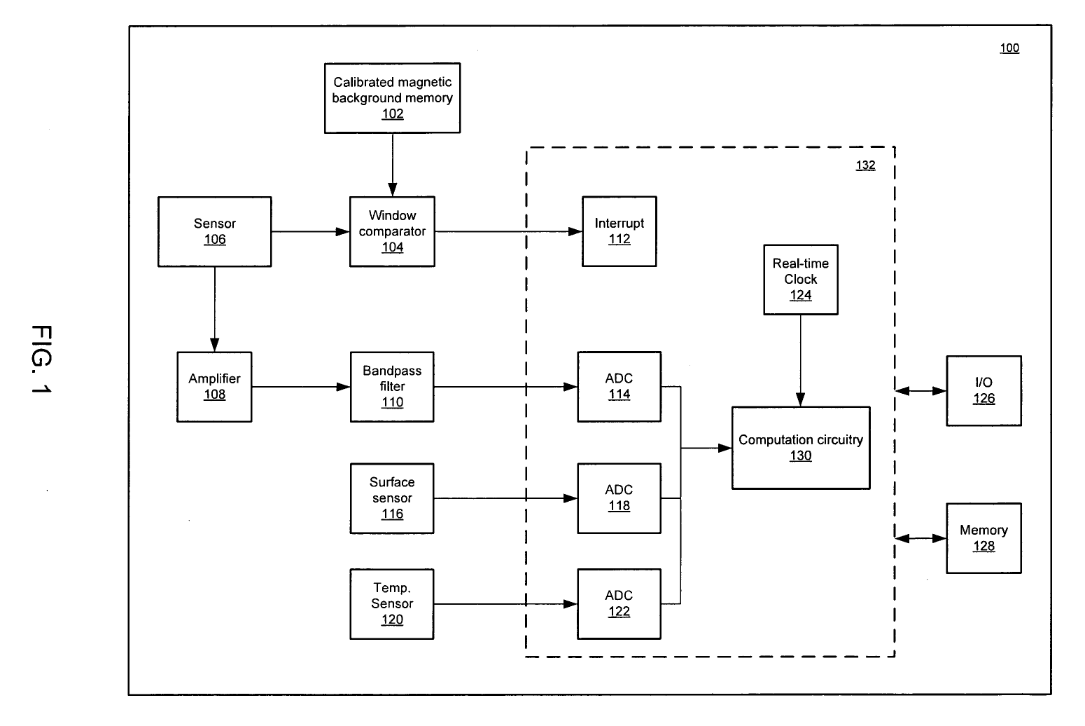

FIG. 1 is a block diagram of one embodiment of a traffic analyzer 100 for analyzing characteristic data of a magnetic permeable mass. The traffic analyzer 100 includes a calibrated magnetic background memory 102 coupled with a window comparator 104, a sensor 106 coupled with the window comparator 104, and an amplifier 108 coupled with the sensor 106 and coupled to a bandpass filter 110. The traffic analyzer 100 also includes a programmable processor 132. The programmable processor 132 is coupled with a surface sensor 116, a temperature sensor 120, and a memory storage device 128. The programmable processor 132 further includes an input/output interface 126, an interrupt 112 coupled with the window comparator 104, a real-time clock 124 coupled with computation circuitry 130, and a first analog-to-digital converter 114, a second analog-to-digital converter 118, and a third analog-to-digital converter 122.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The calibrated background memory storage device 102 is operative to store a threshold value representative of the magnetic field at the Earth's surface. The threshold value may be measured in nanoteslas, microteslas, gauss, or any other now known or later developed units of measurement for measuring magnetic fields, or combinations thereof. In one embodiment, the calibrated background memory storage device 102 is calibrated with the measurements of the magnetic field at the Earth's surface at Uniontown, Pa. However, other locations for calibrating the calibrated background memory storage device 102 are also possible. In another embodiment, a bias is introduced into the calibrated background memory storage device 102 when the calibrated background memory storage device 102 is calibrated. For example, if the calibrated background memory storage device 102 is calibrated at a location other than in Uniontown, Pa., a bias may be introduced that accounts for the difference in magnetic field measurements. The calibrated background memory of the storage device 102 may be further operative to output a voltage representative of the threshold value stored in the calibrated background memory device 102.

The calibrated background memory storage device 102 may be random access memory, cache memory, dynamic random access memory, static random access memory, flash memory, virtual memory, video memory, magnetic memory, optical memory, any known or later developed memory technology, or combinations thereof. In one embodiment, the calibrated background memory storage device 102 is read-only memory (ROM). In another embodiment, the calibrated background memory storage device 102 is random access memory (RAM). In yet another embodiment, the calibrated background memory storage device 102 is an EPROM. In a further embodiment, the calibrated background memory storage device 102 is an EEPROM. The calibrated background memory storage device 102 may also be flash memory, dynamic RAM, static RAM, or combinations thereof.

A window comparator 104 is coupled with the calibrated magnetic background memory device 102 and a sensor 106. In one embodiment, the window comparator 104 is a device having a pair of voltage comparators, in which output indicates whether a measured signal is within a voltage range bounded by an upper threshold and a lower threshold. The window comparator 104 is operative to compare the threshold value stored in the calibrated magnetic background memory storage device 102 and the output of the sensor 106. The output of the sensor 106 may be a voltage representative of the detected change in magnetic field due to a passing vehicle or magnetic permeable mass. The window comparator 104 is also coupled with an interrupt controller 112 of the programmable processor 132. In one embodiment, when the window comparator 104 detects that the output of the sensor 106 exceeds the threshold value of the calibrated magnetic background memory 102, the window comparator 104 sends an output to the interrupt controller 112. As explained below, the interrupt controller 112 is operative to change the power mode of the programmable processor 132 from an inactive state to an active state.

In one embodiment, the sensor 106 is a magnetic field detector. A magnetic field detector is known to one having ordinary skill in the art, and an example thereof may be found in U.S. Pat. Nos. 5,877,705 and 5,748,108. For example, the sensor 106 may include a magnetically variable resistor that changes resistance in response to being exposed to a magnetic field. The sensor 106 is further operative to produce an output of the detected change in the Earth's magnetic field due to a magnetic permeable mass. The output produced by the sensor 106 may be sent to the window comparator 104, the amplifier 108, or combinations thereof. The output produced by the sensor 106 may also be filtered and amplified before being sent to the window comparator 104

The amplifier 108 is operative to amplify the signal from the sensor 106. In one embodiment, the amplifier 108 is a signal conditioning off-amplifier. The amplifier 108 may be further operative to generate an analog signal indicative of changes in the resistance of a magnetically variable resistor of the sensor 106. The amplifier 108 then sends the output of the sensor 106 to a bandpass filter 110 coupled with the amplifier 108.

The bandpass filter 110 may be further coupled with the sensor 106, the window comparator 104, the interrupt controller 112, or combinations thereof. The bandpass filter 110 is operative to filter noise introduced into the output produced by the sensor 106, the amplifier 108, or combinations thereof. For example, electronic disruption in the 50 Hz to 60 Hz range may be caused by power lines, roadside electronic equipment, and other equipment. If the output from the sensor 106, the window comparator 104, the amplifier 108, or combinations thereof are not filtered, this electronic disruption may affect the calculations by the programmable processor 132 or the comparisons by the window comparator 104. In one embodiment, the bandpass filter 110 recognizes electronic disruptions in the 50 Hz to 60 Hz range and filters this noise from the output of the sensor 106, the window comparator 104, the amplifier 108, or combinations thereof. However, in an alternative embodiment, the output from the sensor 106, amplifier 108, the window comparator 104, or combinations thereof, is not filtered. The output from the bandpass filter 110 is then sent to an analog-to-digital converter 114 for analog-to-digital conversion. The digital value may then be sent to the computation circuitry 130 of the programmable processor 132.

The programmable processor 132 is a general processor, a data signal processor, graphics card, graphics chip, personal computer, motherboard, memories, buffers, scan converters, filters, interpolators, field programmable gate array, application-specific integrated circuit, analog circuits, digital circuits, combinations thereof, or any other now known or later developed processor. The programmable processor 132 includes an interrupt controller 112, a real-time clock 124, and a first analog-to-digital converter 114, a second analog-to-digital converter 118, and a third analog-to-digital converter 122. The processor 132 may also be a software module written in a computer programming language, including, but is not limited to, BASIC, C, C++, Java, any other now known or later developed computer programming language, or combinations thereof. The programmable processor 132 further includes computation circuitry 130. The programmable processor 132 additionally includes an input/output interface 126 and a memory storage device 128. The input/output interface 126 may be used to communicate with the programmable processor 132, such as to program or reprogram the programmable processor 132.

In one embodiment, the programmable processor 132 is operative to function in an active state or an inactive state. In an inactive state, the programmable processor 132 utilizes little to no power from a power supply (not shown). In the inactive state, the programmable processor 132 waits for a signal from the interrupt controller 112 to perform computations on the output from the sensor 106. When the programmable processor 132 receives an interrupt from the interrupt controller 112, the programmable processor 132 draws power from the power supply (not shown) to perform computations on the output received from the sensor 106. The programmable processor 132 may receive an interrupt from the interrupt controller 112 when the window comparator 104 determines that the output from the sensor 106 exceeds or meets the threshold value stored in the calibrated magnetic background memory 102.

When the programmable processor 132 is placed into an active state by the interrupt controller 112, the programmable processor 132 performs computations on the output from the sensor 106. The computations may be performed by the computation circuitry 130. The computation circuitry 130 includes, but is not limited to, a control unit, an arithmetic logic unit (ALU), a floating-point unit (FPU), a vector processing unit (VPU), or combinations thereof. The computation circuitry 130 may also include additional units for performing mathematical operations on the output received from the sensor 106.

The computation circuitry 130 is coupled with the analog-to-digital converters 114, 118, and 122, for receiving digital data. In one embodiment, the computation circuitry 130 receives input from the surface sensor 116. The surface sensor 116 may be operative to provide information as to the condition of the surface above or near the traffic analyzer 100. For example, the surface sensor 116 may provide indicators as to whether the surface above or near the traffic analyzer 100 is dry or wet. The computation circuitry 130 is also coupled with a temperature sensor 120. The temperature sensor 120 may be operative to determine the temperature of the surface above the traffic analyzer 100. The computation circuitry 130 is further coupled with a real-time clock 124. The real-time clock 124 is operative to provide a timestamp on the data received from the sensor 106, the surface sensor 116, the temperature sensor 120, or combinations thereof. For example when the computation circuitry 130 operates on the data provided by the sensor 106, the surface sensor 116, or the temperature sensor 120, the computation circuitry 130 can use the real-time clock 124 to timestamp the data.

In one embodiment, the computation circuitry 130 uses the output from the sensor 106 to calculate characteristic data of the vehicle passing the traffic analyzer 100. Characteristic data may include for example, the number of vehicles that have passed the traffic analyzer 100, the length of the vehicle that has passed the traffic analyzer 100, or combinations thereof. Alternatively, the programmable processor 132 may be preprogrammed with baseline information to compare with the output from the sensor 106. Based on a comparison with the baseline information and the output from the sensor 106, the programmable processor 132 may be able to determine the speed of the vehicle passing the traffic analyzer 100.

After the computational circuitry 130 analyzes and uses the output from the sensor 106, the programmable processor 132 saves the characteristic data, such as the speed of the vehicle, the vehicle count, or combinations thereof, into the memory storage device 128. The memory storage device 128 may be random access memory, cache memory, dynamic random access memory, static random access memory, flash memory, virtual memory, video memory, magnetic memory, optical memory, any known or later developed memory technology, or combinations thereof. In one embodiment, the memory storage device 128 is read-only memory (ROM). In another embodiment, the memory storage device 128 is a random access memory (RAM). In yet another embodiment, the memory storage device 128 is an EPROM. In a further embodiment, the memory storage device 128 is an EEPROM. The memory storage device 128 may also be flash memory, dynamic RAM, static RAM, or combinations thereof.

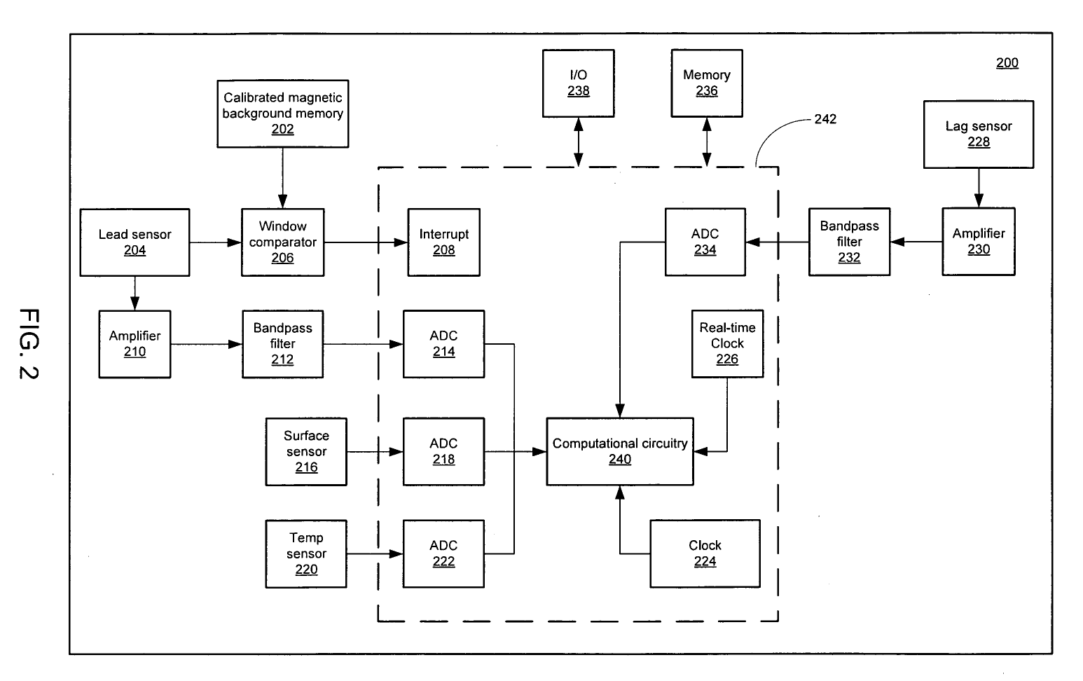

Turning now to FIG. 2 is a block diagram of an alternative embodiment of a traffic analyzer for analyzing characteristic data of a magnetic permeable mass. In this alternative embodiment, a traffic analyzer 200 includes a calibrated magnetic background memory device 202, a lead sensor 204, a lag sensor 228, and the programmable processor 242. As discussed above with respect to FIG. 1 and the sensor 106, the lead sensor 204 and the lag sensor 228 may be magnetic field detectors.

As shown in FIG. 2, the calibrated magnetic background memory device 202 is coupled with a window comparator 206. The window comparator 206 is further coupled with the lead sensor 204 and an interrupt controller 208 on the programmable processor 242. The calibrated magnetic background memory device 202 may be calibrated according to the method previously described with respect to FIG. 1. The window comparator 206 is operative to compare the output of the lead sensor 204 with a threshold value stored in the calibrated magnetic background memory device 202. Where the window comparator 206 detects that the output of the lead sensor 204 meets or exceeds the threshold value stored by the calibrated magnetic background memory device 202, the window comparator 206 sends a comparative output to the interrupt controller 208. The interrupt controller 208 may then send an interrupt to the programmable processor 242 to place the programmable processor 242 in an active state.

The amplifier 210 is operative to amplify the signal from the lead sensor 204. In one embodiment, the amplifier 210 is a signal conditioning off-amplifier. As previously described with respect to the sensor 106 of FIG. 1, the lead sensor 204 of FIG. 2 may include a magnetically variable resistor operative to detect changes in the Earth's magnetic field caused by a passing magnetic permeable mass. The amplifier 210 may be further operative to generate an analog signal indicative of changes in the resistance of a magnetically variable resistor of the lead sensor 204. The amplifier 210 then sends the output of the lead sensor 204 to a bandpass filter 212 coupled with the amplifier 210.

The bandpass filter 212 is operative to filter electronic disturbances from the output of the lead sensor 204, amplifier 210, the window comparator 206, or combinations thereof. In one embodiment, the bandpass filter 212 recognizes electronics disruption in the 50 Hz to 60 Hz range and filters this noise from the output of the lead sensor 204, amplifier 210, the window comparator 206, or combinations thereof. However, in an alternative embodiment, the output from the lead sensor 204, the amplifier 210, the window comparator 206, or combinations thereof, are not filtered. The output from the bandpass filter 212 is then sent to an analog-to-digital converter 214 for analog-to-digital conversion. The digital value may then be sent to the computation circuitry 240 of the programmable processor 242.

In addition to the lead sensor 204, the traffic analyzer 200 includes a lag sensor 228. The lag sensor 228 is operative to generate a second output indicative of the change in magnetic field adjacent the lag sensor 228 in response to a passing magnetic permeable mass, such as a vehicle. The lag sensor 228 is coupled with an amplifier 230, which is operative to amplify the signal from the lag sensor 230. In one embodiment, the amplifier 230 is a signal conditioning off-amplifier. As previously described with respect to the sensor 106 of FIG. 1, the lag sensor 228 of FIG. 2 may include a magnetically variable resistor operative to detect changes in the Earth's magnetic field caused by a passing magnetic permeable mass. The amplifier 230 may be further operative to generate an analog signal indicative of changes in the resistance of a magnetically variable resistor of the lag sensor 228. The amplifier 230 then sends the output of the lag sensor 228 to a bandpass filter 232 coupled with the amplifier 230.

The bandpass filter 232 is operative to filter electronic disturbances from the output of the lag sensor 228, the amplifier 230, or combinations thereof. In one embodiment, the bandpass filter 232 recognizes electronic disruptions in the 50 Hz to 60 Hz range and filters this noise from the output of the lag sensor 228, the amplifier 230, or combinations thereof. However, in an alternative embodiment, the output from the lag sensor 228, the amplifier 230, or combinations thereof, is not filtered. The output from the bandpass filter 232 is then sent to an analog-to-digital converter 234 for analog-to-digital conversion. The digital value may then be sent to the computation circuitry 240 of the programmable processor 242.

The programmable processor 242 is operative to receive input from the window comparator 206, the bandpass filter 212, the surface sensor 216 via the analog-to-digital converter 218, the temperature sensor 220 via the analog-to-digital converter 222, the bandpass filter 232, or combinations thereof. The programmable processor 242 is a general processor, a data signal processor, graphics card, graphics chip, personal computer, motherboard, memories, buffers, scan converters, filters, interpolators, field programmable gate array, application-specific integrated circuit, analog circuits, digital circuits, combinations thereof, or any other now known or later developed processor. The programmable processor 242 includes an interrupt controller 208, a real-time clock 226, several analog-to-digital converters, a clock 224, and computational circuitry 240. The programmable processor 242 may also be a software module written in a computer programming language, including, but is not limited to, BASIC, C, C++, Java, or combinations thereof. The programmable processor 242 additionally includes an input/output interface 238 and a memory storage device 236. The input/output interface 238 may be used to communicate with the programmable processor 242, such as to program or reprogram the programmable processor 242.

Similar to the programmable processor 132 of FIG. 1, the programmable processor 242 of FIG. 2 operates in an active or inactive state. In an inactive state, the programmable processor 242 utilizes little to no power of a power supply (not shown) coupled with the programmable processor 242. In the inactive state, the programmable processor 242 waits for an interrupt from the interrupt controller 208. The interrupt from the interrupt controller 208 is based on a comparative output from the window comparator 206. In one embodiment, the comparative output is based on a comparison between the threshold value stored in the calibrated magnetic background memory device 202 and the output from the lead sensor 204.

When the programmable processor 242 is placed in an active state, the programmable processor waits for input from the lag sensor 228. As previously discussed, the input from the lag sensor 228 may be an analog value converted to a digital value by the analog-to-digital converter 234. When the programmable processor 242 receives the lag sensor 228 output, the computational circuitry 240 compares the timing of the output of the lead sensor 204 with the output of the lag sensor 228 using the clock 224. The computation circuitry 240 includes, but is not limited to, a control unit, an arithmetic logic unit (ALU), a floating-point unit (FPU), a vector processing unit (VPU), or combinations thereof. The computation circuitry 240 may also include additional units for performing mathematical operations on the output received from the lead sensor 204, the lag sensor 228, the surface sensor 216, the temperature sensor 220, or combinations thereof.

The computational circuitry 240 uses the timing of the output between the lag sensor 228 and the lead sensor 204 to determine whether a vehicle has passed the traffic analyzer 200. For example, the clock 224 may measure time in nanoseconds, milliseconds, seconds, minutes, hours, any other now known or later developed measurements of time, or combinations thereof. For example, the clock 224 may be set to measure time in milliseconds. In this embodiment, the programmable processor 242 may be programmed to register a vehicle when the time between the output of the lead sensor 204 and the output of the lag sensor 228 is greater than 2½ ms. Similarly, if the lag sensor 228 is tripped at an interval less than 2½ ms, than the programmable processor 242 may not register that a vehicle has passed. Other intervals of time, such as 5 ms, 10 ns, and four seconds, are also possible. By using clock 224 and the programmable processor 242, the traffic analyzer 200 may eliminate false positives where the output of the lead sensor 204 exceeds the threshold value stored by the calibrated magnetic background memory device 202. Hence, it is possible to register and reliably detect actual vehicles passing the traffic analyzer 200.

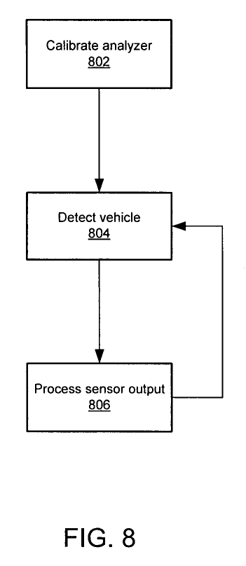

While a vehicle is passing over the traffic analyzer 200, the programmable processor 242 is able to derive characteristic data of the vehicle. Characteristic data includes, but is not limited to, vehicle speed, length, and a vehicle count. As is explained more fully with reference to FIG. 7, to determine the characteristic data of a passing vehicle, the programmable processor 242 creates a magnitude plot using a cross-correlation algorithm based on the detected changes in the magnetic field near the lead sensor 204 and the detected changes in the magnetic field near the lag sensor 228. Based on the output of the lead sensor 204 and the lag sensor 228, the programmable processor 242 is able to derive the length and speed of the vehicle.

After the programmable processor 242 has determined the characteristic data of the vehicle, such as by using computational circuitry 240, the programmable processor 242 then stores the characteristic data in a memory storage device 236 coupled with the programmable processor 242. The memory storage device 242 may be random access memory, cache memory, dynamic random access memory, static random access memory, flash memory, virtual memory, video memory, magnetic memory, optical memory, any known or later developed memory technology, or combinations thereof. In one embodiment, the memory storage device 242 is read-only memory (ROM). In another embodiment, the memory storage device 242 is random access memory (RAM). In yet another embodiment, the memory storage device 242 is an EPROM. In a further embodiment, the memory storage device 242 is an EEPROM. The memory storage device 242 may also be flash memory, dynamic RAM, static RAM, or combinations thereof.

In storing the characteristic data of the vehicle, the programmable processor 242 may use a dynamic distribution classification. A dynamic distribution classification is a method of storing data according to one or more characteristics. For example, the programmable processor 242 may be programmed to store the characteristic data of the vehicle based on the speed of the vehicle. In this example, the programmable processor 242 may be programmed with different categories of speed ranges, such as 0-25 miles per hour (MPH), 26-50 MPH, and 51-100 MPH. Based on the calculated speed of the detected vehicle, the characteristic data associated with the detected vehicle would then be tagged and classified according to the speed ranges. In this manner, numerous vehicles passing the traffic analyzer 200 can be sorted based on speed. As another example, the programmable processor 242 may be programmed to store the characteristic data of the vehicle based on the length of the vehicle. In this example, the categories for storing the characteristic data may include 0-10 feet, 11-30 feet, 31-60 feet, and 60+ feet. In this manner, the speed of the vehicles can be correlated to their length. In another example, the dynamic distribution classification may be based on the output received from the surface sensor 216, the temperature sensor 220, or combinations thereof Furthermore, in both examples above, a vehicle count can be maintained for each of the categories. Hence, data can be extracted from the traffic analyzer 200 that indicates the number of vehicles traveling at a certain speed, or vehicles of a certain weight, or any other category used for the dynamic distribution classification. Thus, more meaningful data can be achieved using the dynamic distribution classification. The distribution classification is dynamic because the programmable processor 242 may be the programmed at a later time to store the data according to a different classification. Hence, the programmable feature of the programmable processor 242 allows a user to alter the distribution classification at a later date or at a time of a user's choosing.

After the programmable processor 242 has calculated the characteristic data of the vehicle and determined the category for storing the characteristic data, the programmable processor 242 uses the real-time clock 226 to timestamp the characteristic data. The real-time clock 226 may be initialized after the traffic analyzer 200 is set up in a roadway or other surface area, or may be configured to start counting time from a predetermined date and time. The timestamp placed by the real-time clock 226 may be in seconds, minutes, hours, days, months, years or combinations thereof. Other time measurements may also be possible. Timestamping the characteristic data permits the user to later view the particular date and time at which the characteristic data was recorded. In addition, the real-time clock 226 may continue to operate after the programmable processor 242 has entered the inactive state. For example, the processor 242 may be configured to enter the inactive state after a predetermined amount of time, such as 10 seconds of no signal from the interrupt controller 208. In this example, the real-time clock 226 will continue to count the date and time even after the processor 242 has entered this inactive state.

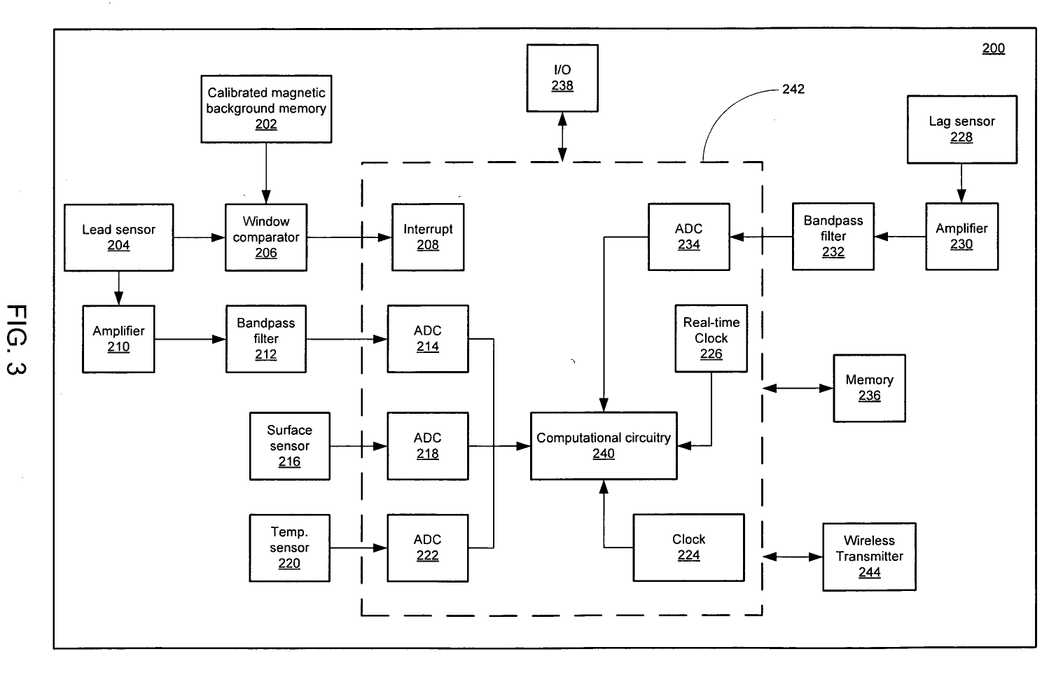

Turning now to FIG. 3 is a block diagram of another embodiment of the traffic analyzer 200 for analyzing characteristic data of a magnetic permeable mass, such as a vehicle. In this embodiment, the traffic analyzer 200 includes a wireless transmitter 244 coupled with the programmable processor 242. The wireless transmitter 244 may also include a wireless receiver. In one embodiment, the wireless transmitter 244 is configured to transmit the characteristic data stored according to the dynamic distribution classification in the memory storage device 236 to another wireless receiver. For example, a user may access the traffic analyzer 200 using the wireless transmitter 244 in addition to, or alternatively to, using the input/output interface 238. The wireless transmitter 244 may communicate using one or more wireless transmission technologies including, but is not limited to, RF, Bluetooth, 802.11a/g/b, Wi-Fi, WiMax, IrDA, any other now known or later developed wireless communication technique, or combinations thereof.

Furthermore, the traffic analyzer 200 may be configured to recover from a failure if the traffic analyzer 200 fails during a period in which it is recording characteristic data. While the traffic analyzer 200 is recording characteristic data, the traffic analyzer 200 associates an incremental value with the characteristic data. In one embodiment, the incremental value is associated with a predetermined time interval, such as 10 minutes, 2 hours, 6 hours, any other known or later developed measurements of time, or combinations thereof. In this manner, when the characteristic data is recorded in the memory storage device 236, the characteristic data includes the incremental value.

If and when the traffic analyzer 200 fails, such as a loss of power or other disturbance, the programmable processor 242 then reads the characteristic data stored in the memory storage device 236 when the traffic analyzer 200 is re-initialized. When the programmable processor 242 reads back the characteristic data, the programmable processor 242 will also read the incremental values stored for one or more sets of characteristic data. As the programmable processor 242 reads back the incremental values for each set of characteristic data, the programmable processor 242 further maintains an internal count of each incremental value read. After reading one or more incremental values, the programmable processor 242 will have an internal count representative of the real time at which the programmable processor 242 failed. The internal count representative of the real time may be the actual time the programmable processor 242 failed or a time when the last characteristic data was recorded. The programmable processor 242 can then update the real-time clock 226 with the incremental count to reflect the actual time after the traffic analyzer 200 failed.

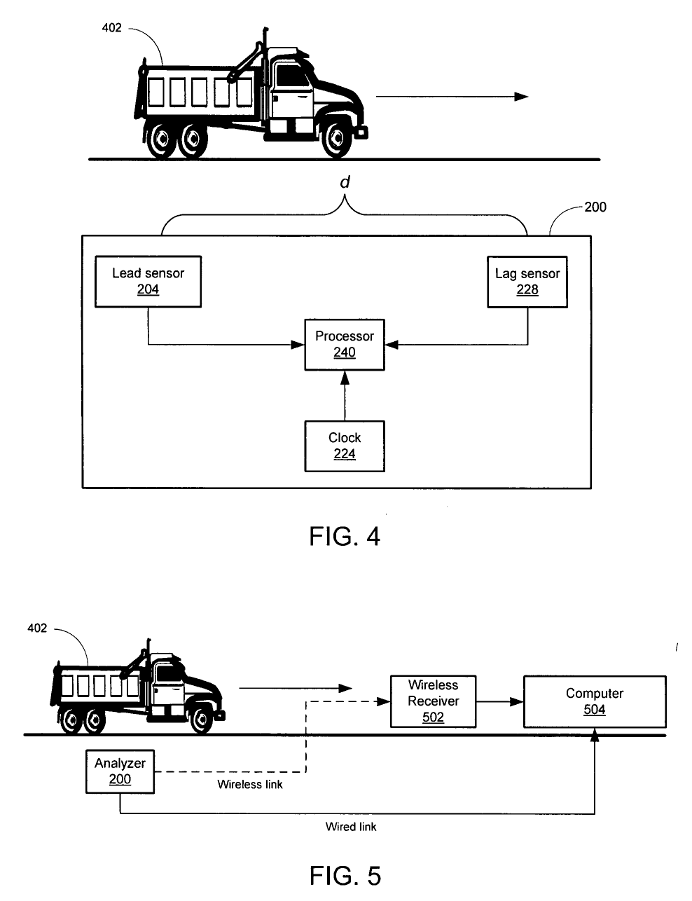

Turning now to FIG. 4 with reference to FIG. 2 is an example of a traffic analyzer 200 in use to detect the characteristic data of a magnetic permeable mass 402. In the example shown in FIG. 4, the magnetic permeable mass 402, in this case a vehicle, passes over the lead sensor 204 of the traffic analyzer 200. The change in the magnetic field near the lead sensor 204 is greater than or exceeds the threshold value stored in the calibrated magnetic background memory storage device 202 and triggers the programmable processor 242 to enter the active state. As the magnetic permeable mass 402 is passing over a predetermined distance d, the lag sensor 228 detects the change in magnetic field near the lag sensor 228 due the passing of the magnetic permeable mass 402. The processor 240 then uses clock 224 to determine whether the magnetic permeable mass 402 was in fact a vehicle, or whether the lead sensor 204 accidentally triggered the programmable processor 242.

Using the distance d between the lead sensor 204 and the lag sensor 228, and the detected change in magnetic field near the lead sensor 204 and the lag sensor 228, the programmable processor 240 is able to derive the characteristic data, in this case the speed and length, of the magnetic permeable mass 402 passing the traffic analyzer 200. The programmable processor 242 then stores the characteristic data of the magnetic permeable mass 402 according to the programmed dynamic distribution classification, which may be based on speed, length, surface conditions, temperature readings, or combinations thereof.

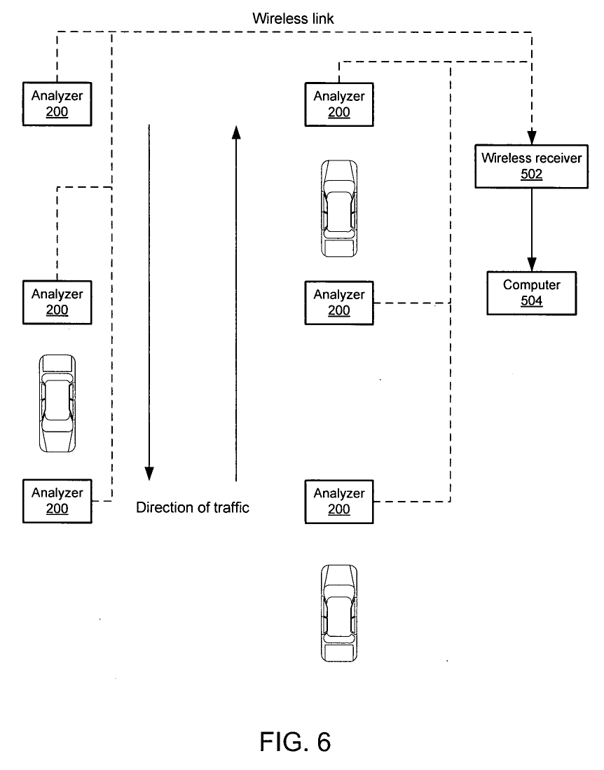

Turning now to FIG. 5 with reference to FIG. 2 is an example of the traffic analyzer 200 in communication with additional systems to analyze the characteristic data of a magnetic permeable mass. In the example shown in FIG. 5, the traffic analyzer 200 is in communication with a wireless receiver 502 and a computer 504. The wireless receiver 502 may also be in communication with the computer 504. The traffic analyzer 200 may use a wireless communication technique, such as RF, Bluetooth, IEEE 802.11a/g/b, or combinations thereof, to communicate with the wireless receiver 502. The traffic analyzer 200 may also use a wired communication technique, such as Ethernet, Point-to-Point Protocol (PPP), High-Level Data Link Control (HDLC), Advanced Data Communication Control Protocol (ADCCP), any now known or later developed communication technique, or combinations thereof, to communicate with the computer 504.

The traffic analyzer 200 may be configured to communicate with the wireless receiver 502, the computer 504, or combinations thereof, at predetermined time intervals while the traffic analyzer 200 is in use. For example, the traffic analyzer 200 may be configured to transmit the characteristic data stored according to the dynamic distribution classification to the wireless receiver 502, the computer 504, or combinations thereof, every 10 minutes while the traffic analyzer 200 is in use. Alternatively, the traffic analyzer 200 may not be configured to transmit the characteristic data based on a predetermined time interval. In addition to, or alternatively to, transmitting data at predetermined time intervals, the traffic analyzer 200 may be configured to allow access from the wireless receiver 502, the computer 504, or combinations thereof.

Furthermore, the wireless receiver 502, the computer 504, or combinations thereof, may be configured to program or reprogram the traffic analyzer 200. For example, a user may use the wireless receiver 502, the computer 504, or combinations thereof to reprogram the dynamic distribution classification the traffic analyzer 200. A user may also use the wireless receiver 502, the computer 504, or combinations thereof, to retrieve the characteristic data from the memory storage device 236 of the traffic analyzer 200.

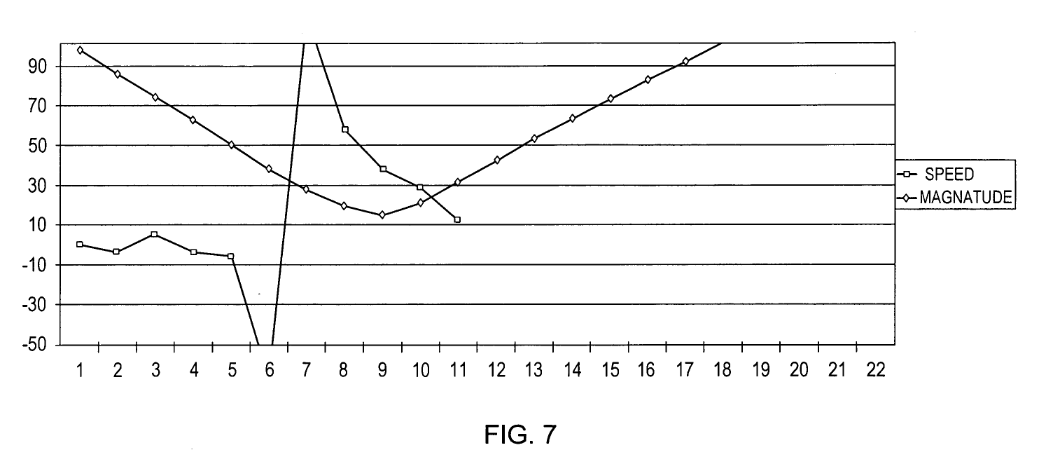

Referring now to FIG. 6 with reference to FIG. 2 and FIG. 5 is an illustration of multiple traffic analyzers 200 in use to analyze the characteristic data of multiple magnetic permeable masses. In the example shown in FIG. 6, the multiple traffic analyzers 200 are in communication with the wireless receiver 502, the computer 504, or combinations thereof. Although a wireless communication technique is shown in FIG. 6, a wired communication technique as discussed previously with respect to FIG. 5 may also be used by the traffic analyzers 200 to communicate with the wireless receiver 502, the computer 504, or combinations thereof. In this manner, multiple analyzers 200 can be used to analyze the flow of traffic as indicated by the arrows indicating the direction of traffic. In addition to, or alternatively to, being in communication with the wireless receiver 502, the computer 504, or combinations thereof, the traffic analyzers 200 may also be communication with one another.

Referring now to FIG. 7 with reference to FIG. 2 is an example of a time-series magnitude plot used to calculate the speed of the magnetic permeable mass according to one embodiment of the traffic analyzer 200. As shown in FIG. 7, the magnitude plot is represented by the graph labeled as “Magnitude” and the calculation of the vehicle speed is represented by the graph labeled as “Speed”. In one embodiment of the traffic analyzer 200, the analog signals from lead sensor 204 and the lag sensor 228, which are separated by a predetermined distance programmed into the programmable processor 242, are digitally sampled for the period of time while the vehicle is over the traffic analyzer 200. Two series of numbers are represented, and these are designated as X and Y.

In general, X and Y represent the sampled data from the lead sensor 204 and the lag sensor 228. In one embodiment, X represents the sampled data from the lead sensor 204 and Y represents the sampled data from the lag sensor 228. The sampled data from the lead sensor 204 or the lag sensor 228 may be the change in magnetic field near the lead sensor 204, the lag sensor 228, or combinations thereof. The sampled data may be sampled in increments of time measured in nanoseconds, milliseconds, seconds, minutes, hours, any other known or later developed measurements of time, or combinations thereof.

The sampled data from the lead sensor 204 and the lag sensor 228 are used to generate two independent waveforms. In one embodiment, the waveforms represent the change in magnetic field above or near the lead sensor 204 and the lag sensor 228 over a period of time. Furthermore, the waveforms may be identical. However, the waveforms may also be shifted in a period of time, such as a multiple of the increment of time used to sample the data, due to the distance between the lead sensor 204 and the lag sensor 228. The programmable processor 242 is operative to determine the shift in time between the sampled data from the lead sensor 204 and the lag sensor 228. Based on the cross-correlation of the shift in time and the distance between the lead sensor 204 and the lag sensor 228, characteristic data, such as speed, vehicle length, vehicle count, or combinations thereof, may be determined.

To cross-correlate the two series, the first two numbers are multiplied together and added to the second number of both series. This mathematical calculation continues for the entire period while a vehicle is passing the traffic analyzer 200. The sum of the multiplications of the first two series of numbers represents a first point on the magnitude plot. Subsequent magnitude points are calculated by shifting the value represented by Y from the previous calculation by 1.

The calculation of each magnitude plot may be represented by the following equations:

M(1)=X(1)*Y(1)+X(2)*Y(2)+X(3)*Y(3)+ . . .

M(2)=X(1)*Y(2)+X(2)*Y(3)+X(3)*Y(4)+ . . .

. . .

M(n)=X(1)*Y(n)+X(2)*Y(n+1)+X(3)*Y(n+2)+ . . .

The computation of the magnitude plot results in a plot having a peak value. The peak value is representative of the point where the two sampled signals from the lead sensor 204 and the lag sensor 228 most closely match. The peak may be further representative of the shift in time between the two signals.

Each step in the magnitude plot is a period of time equal to the period of the sample rate. A coarse answer may be representative of the magnitude step with the largest value multiplied by the sample period. However, it is also possible to obtain an accurate answer by taking the derivative of the values representative of the magnitude plot and solving for zero. Taking the derivative of the magnitude plot may be similar to finding the zero crossing using the slope of a line equation (Y₂−Y₁)/(X₂−X₁). The accurate answer, also refereed to as a fine answer, may be added to the coarse answer. The fine answer may also be less than a sample period. In one embodiment, the programmable processor 242 adds each of the multiplied results and stores the values in the memory storage device 236.

In another embodiment, the programmable processor 242 calculates the values of the magnitude plot by adding, instead of multiplying, and then taking the absolute value before adding the numbers. The accurate answer, as opposed to the coarse answer, may still be calculated in a similar fashion as described above. In this alternative embodiment, less memory may be required in the memory storage device 236 because each of the numbers representative of the values on the magnitude plot result in smaller values. The following equations are representative of this alternative embodiment for calculating the points on the magnitude plot:

M(1)=abs(X(1)+Y(1))+abs(X(2)+Y(2))+abs(X(3)+Y(3))+ . . .

M(2)=abs(X(1)+Y(2))+abs(X(2)+Y(3))+abs(X(3)+Y(4))+ . . .

. . .

M(n)=abs(X(1)+Y(n))+abs(X(2)+Y(n+1))+abs(X(3)+Y(n+2))+ . . .

In yet another alternative embodiment of calculating the values of the magnitude plot, the programmable processor 242 may take the difference of the two series of numbers. In this embodiment, the answer would be representative of the minimum magnitude step. Additionally, with this embodiment, the data size for storing the values of the points on the magnitude plot in the memory storage device 236 is reduced. Furthermore, there may also be an increase in the speed at which algorithm is performed by the programmable processor 242. This minimum value grows as the calculation progresses and the magnitude plot can be scaled to track the minimum, keeping in range of the data size used. This also allows for use of the smallest data size. The following equations are representative of this further alternative embodiment for calculating the points on the magnitude plot:

M(1)=abs(X(1)−Y(1))+abs(X(2)−Y(2))+abs(X(3)−Y(3))+ . . .

M(2)=abs(X(1)−Y(2))+abs(X(2)−Y(3))+abs(X(3)−Y(4))+ . . .

. . .

M(n)=abs(X(1)−Y(n))+abs(X(2)−Y(n+1))+abs(X(3)−Y(n+2))+ . . .

The programmable processor 242 then calculates the speed of the vehicle based on the calculated values of the magnitude plot. The speed of the vehicle passing the traffic analyzer 200 is represented by the time series graph labeled as “Speed” as shown in FIG. 7.

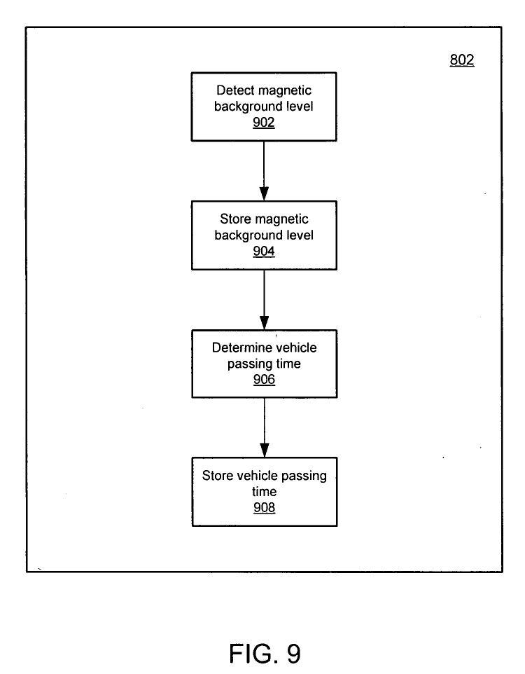

Referring now to FIG. 8 with reference to FIG. 2 is a flow chart of one embodiment of a method for analyzing the characteristic data of a magnetic permeable mass. In one embodiment, the method comprises calibrating the traffic analyzer 200 (Block 802), detecting a magnetic permeable mass, such as a vehicle (Block 804), and then processing the output of the lead sensor 204 and the output of the lag sensor 228 (Block 806).

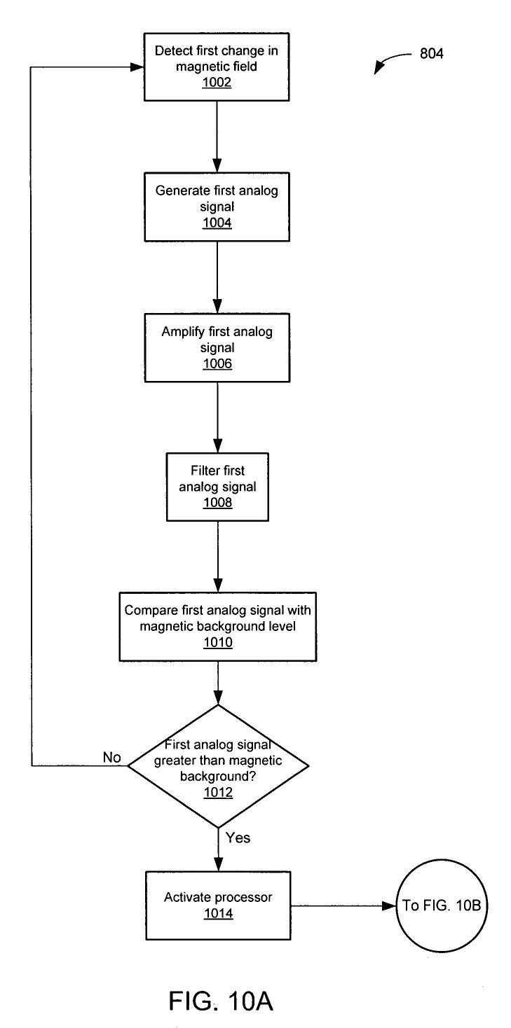

FIG. 9 is a flow chart of one embodiment of a method for analyzing the characteristic data of a magnetic permeable mass. In FIG. 9, a magnetic background level is detected (Block 902). The magnetic background level may be detected at a location on the earth's surface. In one embodiment, the magnetic background level is detected in Uniontown, Pa. Alternatively, a magnetic background level may be detected at a location where the traffic analyzer 200 is being used. If the magnetic background level used to calibrate the traffic analyzer 200 is different from the magnetic background level and location where the traffic analyzer 200 is being used, a bias may be introduced into the measurements taken by the lead sensor 204, the lag sensor 228, or combinations thereof. Where a bias exists, a bias compensator (not shown) may be used to offset the bias introduced into the calibrated traffic analyzer 200.

After detecting a magnetic background level at a location, or a location where the traffic analyzer 200 is to be used (Block 902), the magnetic background level is then stored in the traffic analyzer 200 (Block 904). In one embodiment, the magnetic background level is stored as a threshold value in the calibrated magnetic background memory device 202 of the traffic analyzer 200. The threshold value may then be accessed by the window comparator 206 of the traffic analyzer 200 to compare with the output of the lead sensor 204.

After the magnetic background level is stored as a threshold value in the calibrated magnetic back on memory device 202 (Block 904), a vehicle passing time is then determined (Block 906). The vehicle passing time may be determined (Block 906) before, after, during, or combinations thereof, the magnetic background level is detected (Block 902) and stored as a threshold value (Block 904) in the traffic analyzer 200. In one embodiment, the vehicle passing time is the time that a vehicle should pass the lead sensor 204 and the lag sensor 228 set apart a predetermined distance while traveling at a predetermined speed. For example, the programmable processor 242 may be programmed that the vehicle passing time is 2½ milliseconds. In this example, a magnetic permeable mass would be detected as a vehicle if the magnetic permeable mass passes the lead sensor 204 and then triggers the lag sensor 228 in a time period greater than or equal to 2½ milliseconds. The programmable processor 242 may be programmed with alternative vehicle passing times for vehicles traveling at faster speeds, lower speeds, or combinations thereof. For example, the programmable processors 242 may be programmed with a vehicle passing time of 10 seconds. In this example, a magnetic permeable mass would be detected as a vehicle if the magnetic permeable mass passes the lead sensor 204, and then triggers the lag sensor 228 at a time period greater than or equal to 10 seconds from triggering the lead sensor 204. The programmable processor 242 may be further reprogrammed with alternative vehicle passing times after the traffic analyzer 200 has been placed in a surface, such as a roadway. The programmable processor 242 may be reprogrammed using the input/output interface 238, the wireless transmitter 244, or combinations thereof.

Once the vehicle passing time has been determined (Block 906), the vehicle passing time is then stored in the programmable processor 242 (Block 908). The vehicle passing time may be stored in the memory storage device 236 coupled with the processor 242. Alternatively, the vehicle passing time may be stored in the memory storage device located outside the traffic analyzer 200. In this alternative embodiment, the outside memory storage device is in communication with the traffic analyzer 200 using the input/output interface 238, the wireless transmitter 244, or combinations thereof.

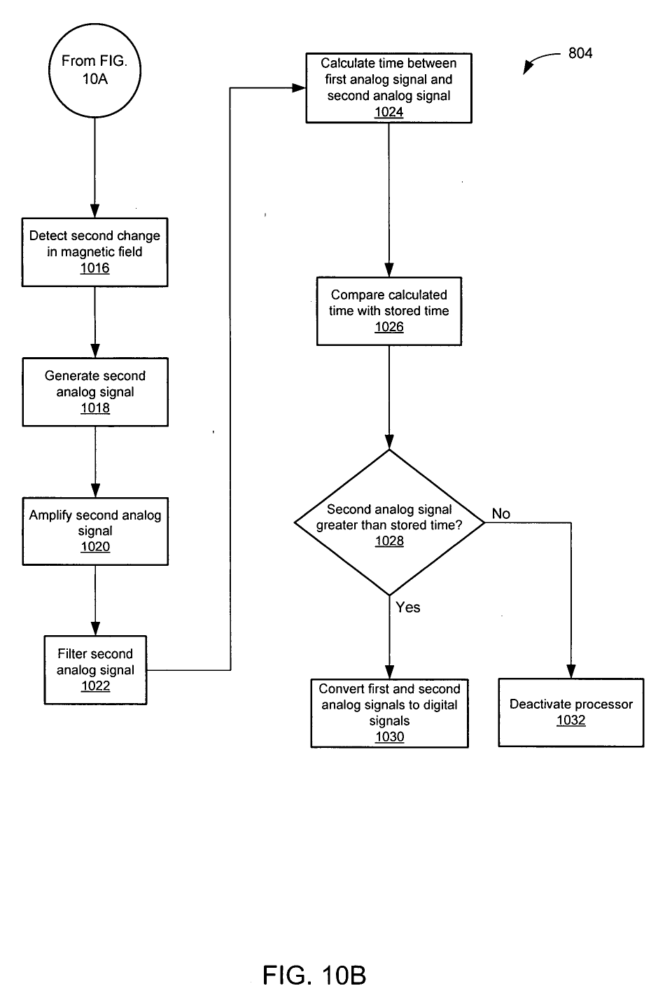

FIG. 10A is a flow chart of one embodiment for detecting a magnetic permeable mass according to the flow chart shown in FIG. 7. As shown in FIG. 10A, the lead sensor 204 detects a first change in the magnetic field located near the lead sensor 204 (Block 1002). When the lead sensor 204 detects the first change in the magnetic field, the lead sensor 204 generates an analog signal indicative of the change (Block 1004). In one embodiment, the first analog signal generated by the lead sensor 204 is amplified by the amplifier 210 (Block 1006). In another embodiment, the amplifier 210 is further operative to generate an analog signal indicative of changes in the resistance of a magnetically variable resistor of the lead sensor 204. The amplified first analog signal is then sent to a bandpass filter 212 for filtering (Block 1008). In one embodiment, the bandpass filter 212 is operative to filter out noise in the 50 Hz to 60 Hz range. Alternative, or additional, ranges are also possible depending on the frequencies of the electronic disturbances surrounding the traffic analyzer 200.

After filtering (Block 1008), the filtered and amplified analog signal is sent to the window comparator 206. Alternatively, the signal output by the lead sensor 204 may not be amplified, filtered, or combinations thereof, before being sent to the window comparator 206. The window comparator 206 then compares the output of the lead sensor 204 with the threshold of value stored in the calibrated magnetic background memory device 202 (Block 1012). Where the window comparator determines that the output of the lead sensor 204 meets or exceeds the threshold stored in the calibrated magnetic background memory device 202, the window comparator 206 then generates an output for the interrupt controller 208. The interrupt controller 208 then generates an interrupt, which places the programmable processor 242 in an active state (Block 1014).

FIG. 10B is a flow chart illustrating the detection of the magnetic permeable mass continued from FIG. 10A. After the processor 242 is placed into an active state (Block 1014), the lag sensor 228 then detects a second change in a magnetic field near the lag sensor 228 due to the passing of the magnetic permeable mass (Block 1016). The lag sensor 228 then generates an output, such as an analog signal, representative of the change in the magnetic field near the lag sensor 228 (Block 1018). After a lag sensor 228 generates an output indicative of the change in the magnetic field near the lag sensor 228 (Block 1018), the output is amplified (Block 1020) and filtered (Block 1022). The amplifier 230 coupled with the lag sensor 228 is operative to amplify the output of the lag sensor 228. The bandpass filter 232 is coupled with the amplifier 232 and filters the amplified output of the lag sensor 228. The bandpass filter 232 may be configured to filter out noise in the 50 Hz to 60 Hz range. Other ranges are also possible depending on the frequencies of electronic disturbances near the traffic analyzer 200.

After the first and second analog signals have been generated, the programmable processor 242 calculates the time between the output of the first analog signal and the output of the second analog signal (Block 1024). As discussed previously with reference to FIG. 2, the programmable processor 242 uses clock 224 to determine the time between the output of the first analog signal and the output of the second analog signal. After calculating the time between the first analog signal and the second analog signal (Block 1024), which may be measured in nanoseconds, milliseconds, seconds, other measurements of time, or combinations thereof, the programmable processor 242 compares the calculated time with the previously stored vehicle passing time (Block 1026). The programmable processor 242 then makes a determination as to whether the time in which the second analog signal was outputted was greater than the stored vehicle passing time (Block 1028). Where the programmable processor 242 determines that the second analog signal was output at a time greater than the stored vehicle passing time, the programmable processor then proceeds to convert the first and second analog signals to digital signals (Block 1030). Alternatively, where the programmable processor 242 determines that the second analog signal was not output at a time greater than the stored vehicle passing time, the programmable processor 242 then enters an inactive state (Block 1032). In the inactive state, the programmable processor 242 waits for a comparative output from the window comparator 206 and an interrupt from the interrupt controller 208.

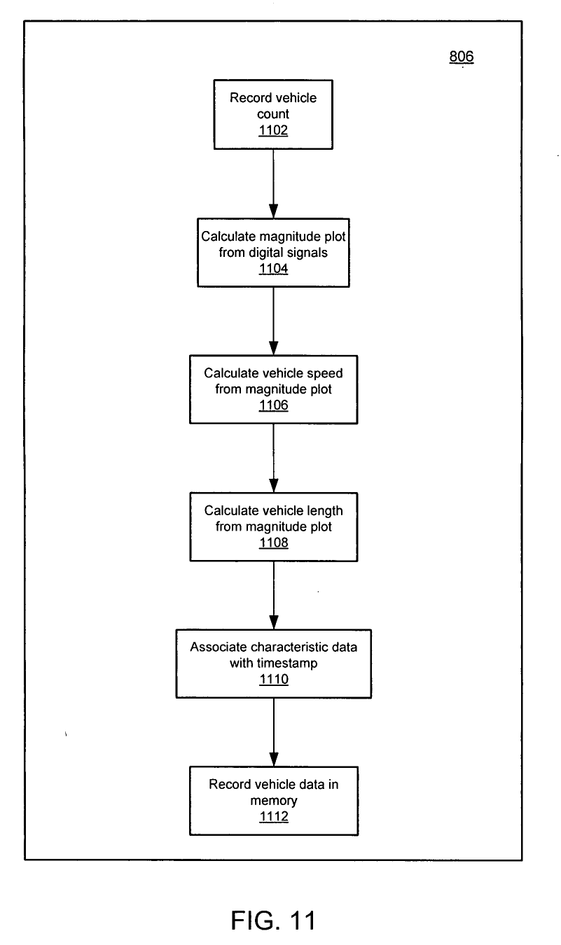

FIG. 11 is a flow chart of one embodiment for processing the output of the sensors of the traffic analyzer 200. In one embodiment, the traffic analyzer 200 counts the number of vehicles that has passed the position of the traffic analyzer 200 (Block 1102). In this embodiment, the traffic analyzer 200 keeps a running tally of all the vehicles that have passed the position of the traffic analyzer 200. Alternatively, or in addition to, counting the number of vehicles that have passed the position of the traffic analyzer 200, the traffic analyzer 200 can maintain a count of the vehicles for each category of dynamic distribution classification. Accordingly, in this embodiment, the traffic analyzer 200 may record the vehicle count after determining the characteristic data for the magnetic permeable mass passing the position of the traffic analyzer 200.

After recording the vehicle count (Block 1102), the programmable processor 242 calculates the magnitude plot according to the method previously described with reference to FIG. 7 (Block 1104). After calculating the magnitude plot of the magnetic permeable mass passing the position of the traffic analyzer 200, the programmable processor 242 calculates the characteristic data of the magnetic permeable mass. In one embodiment, the magnitude plot is included in the characteristic data of the magnetic permeable mass. Alternatively, or in addition to, the magnitude plot, the characteristic data may include the vehicle speed of the passing magnetic permeable mass. As previously described with reference to FIG. 7, the programmable processor 242 can use the magnitude plot to calculate the vehicle speed of the magnetic permeable mass (Block 1106). Other characteristic data includes, but is not limited to, the length of the vehicle. For example, the programmable processor 242 can determine the vehicle length from the magnitude plot (Block 1108). Characteristic data may also include information obtained from the surface sensor 216 and a temperature sensor 220. For example, the surface sensor 216 can provide information as to the moisture on the surface above the traffic analyzer 200, and the temperature sensor 220 can provide the temperature at which the detection of the magnetic permeable mass was recorded.

After determining the characteristic data of the magnetic permeable mass, such as vehicle speed or vehicle length, the programmable processor 242 associates the characteristic data with a timestamp (Block 1110). A timestamp may be measured in seconds, minutes, hours, days, any other now known or later developed measurements of time, or combinations thereof. In one embodiment, the programmable processor 242 uses the real-time clock 226 to timestamp the characteristic data. After timestamping the characteristic data, the programmable processor 242 then stores the characteristic data according to the dynamic distribution classification in memory storage device 236 (Block 1112). As previously discussed, the dynamic distribution classification may based on speed, such that the characteristic data is sorted and stored according to the speed at which the magnetic permeable mass passed the position of the traffic analyzer 200. In this manner, the data in the memory storage device 236 can be organized and retrieved in a logical fashion rather than having to sort the data after retrieving it from the traffic analyzer 200.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A traffic analyzer for detecting a magnetic permeable mass, the traffic analyzer comprising:
a first magnetic field detector operative to produce a first output indicative of a first change in a magnetic field caused by a magnetic permeable mass;
a second magnetic field detector operative to produce a second output indicative of a second change in the magnetic field caused by the magnetic permeable mass, the second magnetic field detector being spaced apart from the first magnetic field detector at a predetermined distance;
a programmable processor operative to receive the first output of the first magnetic field detector and the second output of the second magnetic field detector to produce an output of characteristic data of the magnetic permeable mass, the programmable processor being activated based on a comparison of the first change in the magnetic field and a threshold value; and,
a memory storage device operative to store the characteristic data output by the programmable processor, the programmable processor storing the characteristic data in the memory storage device according to a dynamic distribution classification.

2. The traffic analyzer of claim 1 where the dynamic distribution classification is based on speed.

3. The traffic analyzer of claim 1 where characteristic data comprises a speed value of the magnetic permeable mass.

4. A traffic analyzer for detecting a magnetic permeable mass passing a fixed position, the traffic analyzer comprising:
a calibrated magnetic background memory device operative to store a threshold value;
a magnetic field detector operative to detect a change in a magnetic field, the change being caused by a magnetic permeable mass, and further operative to produce an analog output indicative of the change in the magnetic field;
a window comparator operative to generate a comparative output where the analog output of the magnetic field detector exceeds the threshold value;
an analog-to-digital converter operative to generate a digital output by sampling the analog output; and,
a programmable processor operative to output characteristic data based on the digital output, the programmable processor being activated based on the comparative output.

5. The traffic analyzer of claim 4 further comprising:
a signal condition off-amplifier operative to amplify the analog output; and,
a bandpass filter operative to filter the amplified analog output based on a predetermined frequency, the filtered amplified analog output being used to generate the digital output.

6. The traffic analyzer of claim 4 further comprising a real-time clock operative to calculate a time value based on a pre-determined interval, where the programmable processor is further operative to associate the characteristic data with the calculated time value.

7. The traffic analyzer of claim 4 further comprising memory operative to store the characteristic data output by the programmable processor.

8. The traffic analyzer of claim 7, where the memory is flash memory.

9. The traffic analyzer of claim 4, where the characteristic data comprises a frequency value of magnetic permeable masses that have passed the fixed position.

10. The traffic analyzer of claim 4, further comprising a wireless transmitter operative to wirelessly transmit the characteristic data output by the programmable processor.

11. A traffic analyzer for detecting a magnetic permeable mass passing a fixed position, the traffic analyzer comprising:
a calibrated magnetic background memory device calibrated with a threshold value;
a first magnetic field detector operative to detect a first change in a first magnetic field, the first change being caused by a magnetic permeable mass, and further operative to generate a first analog output indicative of the first change in the magnetic field;
a window comparator operative to generate a comparative output where the first analog output exceeds the magnetic background value;
a second magnetic field detector operative to detect a second change in the magnetic field, the second change caused by the magnetic permeable mass, and further operative to generate a second analog output indicative of the second change in the magnetic field;
a first analog-to-digital converter operative to generate a first digital output by sampling the first analog output;
a second analog-to-digital converter operative to generate a second digital output by sampling the second analog output; and,
a programmable processor operative to generate characteristic data indicative of the magnetic permeable mass based on the first digital output and the second digital output, the programmable processor being activated based on the comparative output.

12. The traffic analyzer of claim 11, where the programmable processor is further operative to determine whether the magnetic permeable mass is a vehicle based on comparing the time of the detected first change with the time of the detected second change.

13. The traffic analyzer of claim 11, further comprising:
a first signal conditioning off-amplifier operative to amplify the first analog output;
a second signal conditioning off-amplifier operative to amplify the second analog output;
a first bandpass filter operative to filter the first amplified analog output based on a predetermined frequency, the first filtered amplified analog output being used to generate the first digital output; and,
a second bandpass filter operative to filter the second amplified analog output based on a predetermined frequency, the second filtered amplified analog output being used to generate the second digital output.

14. The traffic analyzer of claim 11, further comprising a real-time clock operative to calculate a time value based on a pre-determined interval, where the programmable processor is further operative to associate the characteristic data with the calculated time value.

15. The traffic analyzer of claim 11, further comprising memory operative to store the characteristic data output by the programmable processor.

16. The traffic analyzer of claim 15, where the characteristic data is stored in the memory using a dynamic distribution classification.

17. The traffic analyzer of claim 15, where the memory is flash memory.

18. The traffic analyzer of claim 11, where the characteristic data comprises a frequency value of magnetic permeable masses that have passed the fixed position.

19. The traffic analyzer of claim 11, where the characteristic data comprises a speed value of the magnetic permeable mass.

20. The traffic analyzer of claim 11, further comprising a wireless transmitter operative to wirelessly transmit the characteristic data.

21. A method for detecting a magnetic permeable mass passing a fixed position, the method comprising:
determining a threshold value;
detecting a change in a magnetic field in response to a magnetic permeable mass passing a fixed position;
generating an analog output indicative of the detected change in the magnetic field;
comparing the analog output with the threshold value;
generating a comparative output where the analog output value exceeds the threshold value;
generating a digital output by sampling the analog output; and,
activating a programmable processor to output characteristic data based on the digital output, the programmable processor being activated based on the comparative output.

22. The method of claim 21, further comprising:
amplifying the analog output; and,
filtering the amplified analog output based on a predetermined frequency, the filtered amplified analog output being used to generate the digital output value.

23. The method of method 21, further comprising:
calculating a time value based on a pre-determined interval; and,
associating the characteristic data with the calculated time value.

24. The method of claim 21 further comprising storing the characteristic data in memory.

25. The method of claim 24, where the memory is flash memory.

26. The method of claim 21, where the characteristic data comprises a frequency value of magnetic permeable masses that have passed the fixed position.

27. The method of claim 21, further comprising wirelessly transmitting the characteristic data.

28. A method for detecting a magnetic permeable mass passing a fixed position, the method comprising:
determining a threshold value;
detecting a first change in a magnetic field in response to a magnetic permeable mass passing a fixed position;
generating a first analog output indicative of the detected first change in the magnetic field;
comparing the first analog output with the threshold value;
generating a comparative output where the first analog output exceeds the threshold value;
detecting a second change in the magnetic field in response to the magnetic permeable mass passing the fixed position;
generating a second analog output indicative of the detected second change in the second magnetic field;
generating a first digital output by sampling the first analog output;
generating a second digital output by sampling the second analog output; and,
activating a programmable processor to calculate characteristic data of the magnetic permeable mass based on the first digital output and the second digital output, the programmable processor being activated based on the comparative output.

29. The method of claim 28, further comprising determining whether the magnetic permeable mass is a vehicle based on calculating the time between the detected first change the time of the detected second change; and comparing the calculated time between the detected first change and the detected second change with a predetermined time value.

30. The method of claim 28, wherein the characteristic data of the magnetic permeable mass is calculated by correlating the first digital output with the second digital output.

31. The method of claim 30, wherein correlating the first digital output with the second digital output comprises using the programmable processor to calculate at least one point of a magnitude plot, wherein the at least one point is calculated by computing the absolute value of the summation of the first digital output and the second digital output.

32. The method of claim 30, wherein the correlating the first digital output value with the second digital output comprises using the programming processor to calculate at least one point of a magnitude plot, wherein the at least one point is calculated by computing the absolute value of the difference between the first digital output and the second digital output.

33. The method of claim 28 further comprising:
amplifying the first analog output;
amplifying the second analog output;
filtering the first amplified analog output based on a predetermined frequency, the first filtered amplified analog output being used to generate the first digital output; and,
filtering the second amplified analog output based on a predetermined frequency, the second filtered amplified analog output being used to generate the second digital output.

34. The method of claim 28 further comprising:
calculating a time value based on a pre-determined interval; and,
associating the characteristic data with the calculated time value.

35. The method of claim 28 further comprising storing the characteristic data in memory.

36. The method of claim 35, where the characteristic data is stored in the memory using a dynamic distribution classification.

37. The method of claim 35, where the memory is flash memory.

38. The method of claim 28, where the characteristic data comprises a frequency value of magnetic permeable masses that have passed the fixed position.

39. The method of claim 28, where the characteristic data comprises a speed value of the magnetic permeable mass.

40. The method of claim 28, further comprising wirelessly transmitting the characteristic data.

41. A method for reinitializing a traffic analyzer after a failure, the method comprising:
associating an incremental value with a predetermined time interval;
detecting a change in a magnetic field in response to a magnetic permeable mass passing a fixed position;
generating a detected output indicative of the detected change in the magnetic field;
generating a comparative output where the detected output exceeds a threshold value;
activating a programmable processor to store characteristic data in a memory storage device based on the detected output, the programmable processor being activated based on the comparative output;
storing the characteristic data in the memory storage device where the characteristic data is associated with the incremental value;
reading the characteristic data from the memory storage device after a failure to determine the incremental value associated with the characteristic data;
maintaining an incremental count based on determining the incremental value associated with the characteristic data; and,
updating a real-time clock based on the incremental count.
